(19) United States
(12) Patent Application Publication
(10) Pub. No.: US 2005/0084575 A1
(43) Pub. Date: Apr. 21, 2005

(54) Citrus sinensis solids washing and products

(76) Inventor: Craig Philipp, Bradenton, FL (US)

Correspondence Address: RYNDAK & SURI, 30 NORTH LASALLE STREET, SUITE 2630, CHICAGO, IL, 60602, US

(21) Appl. No.: 10/690,308

(22) Filed: Oct. 21, 2003

(51) Int. Cl. A23P 1/00

(52) U.S. Cl. 426/495

(57) ABSTRACT

Citrus sinensis round orange cultivar juice sources are subjected to separation to provide a solids fraction and a serum fraction. The separated solids fraction is washed with an organic solvent composition to remove a substantial portion of the oil in order to provide a reduced-oil solids source. This reduced-oil solids source is useful for recombining with the serum fraction or for combining with other juice sources for providing a whole juice having a reduced-oil content. Washing can remove off-flavor components, providing a similarly useful washed solids product. Positive sensory components as well as other components reside within the washing slurry stream. Separation techniques can be used to recover from this stream positive compounds that are useful in a flavor addback composition, for example.

### BACKGROUND OF THE INVENTION

1. Field of the Invention

This invention generally relates to orange juice methods and products which involve separating solids from round orange juice sources. More particularly, the invention is useful in the field of not-from-concentrate (NFC) orange juice and improving same by procedures that separate, wash and combine components present in the NFC juice supply, with the objective of removing juice-supply components which are detrimental to sensory attributes of the juice. In an embodiment, positive components are recovered and have a vulnerable flavor addback use.

2. Description of the Related Art

It is generally known to separate orange juice into fractions such as a serum or liquid phase and a solids or pulp phase. Known means for effecting such separation include centrifugation and filtration technologies. Often this separation is accomplished for one of two purposes. One usual purpose is for using collected pulp products. Another is in the context of preparing from-concentrate juices wherein the separated serum is concentrated and the previously separated pulp fraction is recombined with the thus concentrated juice.

U.S. Pat. No. 2,724,652 shows separating pulp from extracted juice by the use of a centrifuge. Concentration is practiced, the pulp is pasteurized, and the pulp is recombined with the concentrated juice. In this way, the pasteurized pulp is mixed with the concentrated liquid for purposes of preparing concentrated juices having pulp which has not been subjected to the rigors of concentration. U.S. Pat. No. 4,374,865 and No. 4,463,025 show a citrus juice process within which juice is extracted, pulp is separated, and the pulp then is recombined with the concentrated juice stream. Juice blending is suggested for further optimization.

It is generally known that sensory, aroma and flavor components tend to be present in the sinking solids or insoluble solids, often referred to as sinking pulp, of a citrus juice, while other components tend to be found more extensively in the liquid phase or serum portion of the juice. For example, early on it was suggested that orange oil existed as an adsorbed layer on the sinking pulp of orange juice, discussed in Baleir, et al., “Exploratory Experiments to Identify Chemical Reactions Causing Flavor Deterioration During Storage of Canned Orange Juice, I. Incompatibility of Peel-Oil Constituent with the Acid Juice”, Journal of Food Research, 17, 235 (1952). Others have observed that oil is found primarily in the pulp of orange juice. Scott, et al., “Composition of Orange Juice Cloud”, Journal of Food Science, 30, 1833 (1965); and Pelg, et al., “Production of Frozen Orange Juice Concentrate from Centrifugally Separated Serum and Pulp”, Journal of Food Science, 35, 649 (1970).

Radford, et al., “Distribution of Volatile Compounds Between the Pulp and Serum of Some Fruit Juices”, Journal of Agricultural Food Chemistry, Vol. 22, No. 6 (1974) made several evaluations regarding volatile flavor compounds of orange juice. This article observed that 98% of the limonene in an orange juice sample was recovered from the pulp phase, while only 2% was recovered from the serum phase. Other hydrocarbons such as alpha-pinene, sabinene, mycrene, and valencene were found almost exclusively in the pulp phase, whereas esters, alcohols, and aldehydes were found almost exclusively in the serum phase.

Wiener U.S. Pat. No. 4,335,143 proposes using dried albedo clouding agent for beverages from an albedo-containing material which is first comminuted to form a slurry. The slurry is separated to obtain a liquid filtrate containing suspended and colloidal albedo cloud agent particles, which are isolated from the filtrate and washed to remove undesirable off-flavors from the albedo particles. These washed albedo particles then are spray dried or the like. This requires a non-juice starting material, such as peel from juice extraction.

Altomari U.S. Pat. No. 4,526,794 also focuses upon albedo processing. This patent proposes using an alcoholic solution to deflavorize and decolorize the albedo and remove certain carbohydrates.

Patents such as Harris U.S. Pat. No. 5,820,915, No. 5,962,044, No. 5,990,154 and No. 5,993,887, relate to preparing so-called first-pass effective citrus-derived substances, primarily from grapefruit sources. Such suggest extracting a citrus-derived product with a 60 percent alcohol solution to reduce the concentration of components such as phototoxic furocoumarins. The prepared citrus-derived products are said to include citrus extract, citrus concentrate, citrus peel, citrus juice, citrus oil and citrus nectars.

While the art generally has noted differences in the make-up of pulp or solids phases of orange juices on the one hand and the make-up of liquid or serum phases of orange juices on the other hand, recognition of these overall differences, on the whole, has not led to significant direct improvement of actual orange juice products. This is particularly true for NFC juice products.

One challenge facing the NFC orange juice industry is the problem of how to include less desirable NFC orange juice sources in commercially marketed products without detrimentally affecting the flavor and/or sensory attributes of the finished product intended for consumer consumption. Examples of round orange, or Citrus sinensis juice sources from freshly extracted round orange or Citrus sinensis fruit include certain juice oranges that have taste, aroma and/or sensory properties which are less desirable or inferior to preferred orange juice sources such as Valencia Citrus sinensis orange cultivars, which for many years have been considered the prime orange cultivar for juice products, including NFC juice products.

With more particular reference to the more inferior sources of orange juice, one type is early-season harvested Citrus sinensis fruit which mature earlier than Valencia fruit. These include so-called early-to-mid-season Citrus sinensis fruit, including Hamlin, Pineapple and Parson Brown cultivars. Generally, these are referred to herein as early season Citrus sinensis orange juice sources. Another inferior source of freshly squeezed whole juice is the so-called “tight end” juice which is produced during orange juice extraction. This is the high solids stream produced in the last section of the finisher in citrus juice production. Tight end juice is typically collected during a phase of the operation where juice having unusually large quantities of undesirable solids or oil components make their way into the juice. Whatever the ultimate source, these more inferior sources originate from round orange cultivars, which typically belong to the Citrus sinensis category of citrus fruit.

Citrus sinensis NFC juice products are well-known and meet certain standards to be labeled as NFC juice products. These standards include that the juice product was prepared without any concentrating or reconstituting. Traditionally, this requirement has been achieved by maintaining purely whole juices, either as freshly extracted Citrus sinensis juice or as such juice which is stored in whole juice form, such as under frozen conditions. NFC juices, in accordance with good manufacturing practices are pasteurized products. It is often the case that the freshly extracted juices and the stored juices are blended in order to provide a supply of pasteurized NFC Citrus sinensis juice.

Because Citrus sinensis fruit is harvested through only certain times of the year, it is difficult for NFC juice producers to maintain a substantially consistent product throughout the calendar year. For example, there is virtually no Citrus sinensis harvesting during the summer months in the Northern Hemisphere, and NFC production must rely substantially exclusively upon stored juice sources during this time frame.

During other times of the year, or under harvesting conditions at which only more inferior fresh fruit sources are available, NFC products can then be improved by incorporating a so-called “flavor addback” into the NFC juice product. A flavor addback is a typically proprietary composition of naturally occurring components which are judged to impart improved flavor attributes to an NFC product. A typical flavor addback will include one or more volatiles, aromatics, oils, and the like which are intended to impart improved flavor notes to an NFC product or blend which is not up to the flavor standards of the NFC juice producer.

There is accordingly a need for approaches which will allow NFC juice producers to improve upon the Citrus sinensis sources which are available during any given harvesting season, as well as during non-harvesting seasons for Citrus sinensis fruits. Another need is for a good source of components for flavor addback systems. It is recognized herein that an advantageous flavor addback approach would be to use sources therefor that do not deplete the good flavor aspects of naturally occurring, freshly extracted and pasteurized NFC juice which might not require any flavor addback because of its excellent flavor attributes.

The present invention successfully responds to these needs by providing the solution that includes Citrus sinensis juice separation, solvent washing, and inclusion of the treated components in Citrus sinensis juice products. An important aspect of the invention is to take advantage of the propensity of flavor and sensory components to be found within sinking solids within a Citrus sinensis juice. By separating sinking solids from the liquid or serum portion of the juice, the separated solids portion is more readily treated in order to achieve what can be generally characterized as removal of negative components and collection of positive components, each to be used as generally described herein.

### SUMMARY OF THE INVENTION

In accordance with the present invention, whole orange juice is subjected to a separating procedure in order to obtain a separated solids fraction which contains much of the naturally occurring oil and flavor elements of the whole juice. The remainder of the juice is a reduced-solids juice source which has many negative sensory and flavor attributes removed from it. The solids fraction which had been separated then is washed with an organic solvent so as to remove a large percentage of the oil from the original whole juice, thereby removing a primary source of negative and/or bitter flavor ingredients from the solids. This provides a source of solids which is enhanced considerably over the pre-washed condition. The thus-enhanced solids provide an improved whole juice when recombined with the liquid or serum phase from which they were removed. In effect, the whole juice is reassembled, but minus the negative components in order to achieve a recombination embodiment of the invention.

In another embodiment, oil and off-flavor components of whole, unconcentrated Citrus sinensis juice are removed therefrom by separating and washing the solids fraction. These can be combined with whole juice sources which can benefit from adding solids thereto without also adding substantial quantities of oil or off-flavor components normally associated therewith.

In a further embodiment, positive flavor components are recovered from Citrus sinensis juice sources in a procedure which includes separating and washing the solids fraction of a Citrus sinensis source and recovering, from the washed and separated solids, positive flavor components which had been present in the solids fraction of the Citrus sinensis juice. The thus-recovered positive flavor components provide a flavor addback or addback component which enhances the value of the whole NFC juice into which it is incorporated.

A general object of the present invention is to provide an improved orange juice and method of its production which separates sinking solids therefrom, treats the solids, and combines same with a suitable juice source in order to provide an enhanced orange juice product. Another object is to supply components from a washed solids as flavor addback components.

In an aspect of the present invention, Citrus sinensis whole orange juice sources have components removed therefrom. The removed components typically are in the so-called sinking solids category, and they are combined with substantial quantities of the citrus oil and many of the flavor components, including bitter components such as limonin. These negative components can be removed and the thereby improved sinking solids returned to the juice.

In another aspect of the invention, which can be combined with other aspects hereof, Citrus sinensis sources that are separated into solids and serum fractions are used such that the thereby-improved serum fraction functions as a reduced-solids juice which can be used as is or combined with other juice sources. A byproduct wash fraction can be subjected to discriminating separation procedures which allow the identification and collection of one or more positive components which had been included within the previously separated wash fraction. Each positive component, which could be an advantageous flavor compound or complex, can be added to another juice source or addback carrier in order to thereby enhance flavor and/or sensory attributes of that juice. Other separated components can be considered to have negative flavor attributes. These need not be discarded. They can be collected for use as colorants, as phytochemicals or as flavor sources for other juice products or foods, such as to impart a lemon type of flavor. Other uses will be appreciated in the art.

Other objects, aspects and advantageous of the present invention, including combinations thereof, will be understood from the following description according to preferred embodiments of the present invention.

### DESCRIPTION OF THE PREFERRED EMBODIMENTS

Round orange Citrus sinensis juices constitute the starting materials for the invention. They are extracted in commercial-scale, industrial-quality extractors which are well-known in the juice processing art. While the operational steps of the invention can be applied to most whole juices, the advantages of the invention are particularly well suited for Citrus sinensis whole juices that are less than fully desirable for top quality NFC orange juice products.

Explicit examples of starting materials which can benefit most from the invention are juices commercially extracted from Hamlin round orange cultivars, which are by far the most widely used early/mid-season round orange cultivars in at least the State of Florida. Typically, these Hamlin juice oranges, when harvested early in the early/mid-growing season, have relatively high contents of components that have undesirable flavor attributes. These include oil components and terpenes such as limonin. Other Citrus sinensis cultivar juices which can benefit from the present invention are those from the Pineapple and the Parson Brown cultivars. Extracting and pasteurizing these cultivars into NFC juice early in their respective seasons can result in disagreeable flavor notes which can be successfully addressed by the invention. Other juice sources which are particularly suitable for the present invention are those originating from the “tight end” portion of juice from the extractor and finisher equipment of commercial production. Often, such tight end juice flows are discarded or diverted away from use in top quality NFC Citrus sinensis juice production. As used herein, these types of juice sources are referred to as Citrus sinensis juice sources.

The citrus industry commonly describes at least two types of pulp in juice processing and products in order to characterize suspended insoluble material in citrus juice. One type, characterized herein as “solids”, is commonly referred to as sinking pulp while the other is commonly referred to as floating pulp.

Sinking pulp can be referred to by different terms, such as sinking solids. Other terms used in this regard include insoluble solids, bottom pulp and background pulp. Generally speaking, such sinking solids or sinking pulp are made up of insoluble materials and are generally not sensed on the tongue as discrete particles. Generally, the particle sizes of sinking solids are not greater than about 0.5 mm.

Floating pulp is present in some orange juices. This is the name typically given to pulp that imparts mouthfeel to orange juice. Floating pulp does not settle in orange juice and is commonly added to commercial orange juice products to provide a different “fresh-squeezed” appeal. Such floating pulp typically is distinguished from the sinking pulp or sinking solids phase or component which is the solids component involved in the present method and product.

The citrus industry uses a centrifugation method to measure sinking pulp as a volume fraction of the juice. Typical sinking pulp values in orange juice range from about 5 to about 15 volume percent, typically between about 8 and about 12 volume percent, based upon the total weight of the orange juice. In many juices, the natural sinking solids content is about 12 volume percent, based upon the total volume of the juice.

In a typical orange juice extraction process, the Citrus sinensis round orange fruit is mechanically squeezed or reamed to yield a highly pulpy juice. Rag and seeds are removed. This mixture of pulp and juice often is clarified by a so-called finisher, which separates the pulp from the juice by means of a sive mechanism. This pulp stream then is recovered for floating pulp usage. The juice stream coming out of the finisher apparatus contains the sinking pulp or sinking solids that are too small to be captured by the finisher sive. This is a typical freshly extracted whole juice source which can be used in preparing NFC orange juice products. Pasteurization normally will be carried out within a few hours of extraction and preferably no later than about one day after extraction.

In accordance with the present invention, this juice stream is separated into a solids phase, or a sinking pulp or sinking solids phase, and a serum or liquid phase. The serum or liquid phase is that which remains after separation of the sinking solids. The sinking solids phase includes a substantial portion of the oil in the juice, up to as much as about 98 percent of the oil in the juice being associated with the solids phase, typically at least about 70 percent. Also present in large proportions in a typical solids phase are off-flavors and bitter compounds such as limonin, as well as components having positive flavor attributes.

Preferred separation techniques embody centrifugation action. It is generally known that sinking solids can be separated out of the juice stream by centrifugation in order to help control juice viscosity when a juice stream is at a sinking solids level in excess of about 15 percent by volume, based upon the total volume of the juice stream. In accordance with the present invention, a large proportion of the sinking solids are separated from the juice stream, with virtually all of the sinking solids being removed if so desired. Centrifugation also forms the serum phase, which generally is that which remains after rag, seed and sinking solids are separated from the juice. The same phase typically comprises water and compounds giving flavor and aroma to the orange juice.

Prior to separation according to the invention, the Citrus sinensis juice stream contains a complex mixture of volatile aroma compounds that vary as a result of numerous factors. These factors include the particular cultivar from which the juice originates, maturity level of the harvested fruit, fruit processing conditions, and fruit and juice handling and storage conditions. Major classes of compounds which are involved in juice flavor and aroma characteristics are alcohols, aldehydes esters and hydrocarbons. These compounds exist in the peel and/or the juice of the whole Citrus sinensis fruit. Compounds from the peel, which often are referred to as peel oil, typically are the hydrocarbons and aldehydes which are not water-soluble. For example, limonene is the major constituent of orange peel oil, typically accounting for greater than 90 percent of its volume. So-called essence oil contains mainly limonene, while so-called essence aroma contains water-soluble compounds.

After separation, the sinking solids are subjected to organic solvent washing. Preferred solvents are alcohols which are from C-2 to C-8, as well as other organic solvents such as polyols, phenol, acetone, methylene chloride, ethyl acetate, and other hydrocarbons such as hexane, hexane and octane. Preferred organic solvents are those which are suitable for uses involving food or beverage contact. Ethanol is especially preferred because of its ease of use, relatively low cost, ready availability, effectiveness and lack of toxicity issues. Organic solvents make up between about 40 weight percent and about 100 weight percent of the wash composition, with the balance being water.

Generally speaking, the greater the organic solids content in the wash composition, the greater the removal of organic components from the solids phase. Stripping away virtually all of the organic components results in particularly bland washed solids. This allows for replacement of solids without reintroducing all of the oil and flavor components. The result is neutralization which can be followed by flavor addition so as to provide a flavor benefit. The solvent also removes some of the solids, resulting in a reduction in viscosity by washing the sinking solids or bottom solids. Solvent washing typically dissolves some of the undesirable compounds. For example, ethanol will dissolve limonin, thus reducing bitterness.

It is important to remove all of the organic solvent so as to maintain the standards for not-from-concentrate juices. A preferred method is flash drying, although other methods of solvent removal can be practiced. Flash drying of solids will remove substantially all of the organic solvent in the system.

Because a large fraction of the oil or other negative components is associated with the solids component that is separated and washed according to the invention, it is possible to recombine the washed juice solids with the serum or liquid option of the juice from which they originated, which thereby achieves a substantial reduction of oil and negative components because they had been removed from the juice solids which are recombined with the juice. Alternatively, the bland or neutral flavor juice solids prepared by washing according to the invention could be used as a base for another beverage or as a so-called tasting solution for another beverage, or a tasting solution that is almost absent of volatile compounds.

The following Examples illustrate certain aspects of the invention and certain embodiments thereof.

### EXAMPLE 1

One gallon of juice was centrifuged for 10 minutes at 7,000 rpm. The thus-formed liquid fraction was decanted leaving only the sinking solids in the centrifuge container. Then, 500 ml of ethanol (150 proof) was added to the centrifuge container, and the product was homogenized. The resulting ethanol slurry was gently mixed in an orbital shaker for about 10 minutes, followed by centrifuging at 7,000 rpm for 10 minutes. Decanting was repeated, followed by ethanol addition, homogenization, mixing and further centrifuging.

After the last aliquoit of ethanol was decanted, water was added to the solids, and the product was homogenized so as to remove excess ethanol. The resulting water slurry was gently stirred in an orbital shaker for 10 minutes, followed by centrifuging at 7,000 rpm for 10 minutes. Another water washing, homogenizing, stirring and centrifuging was practiced to remove further ethanol.

The liquid fraction from the centrifuging of the whole juice was then combined with the alcohol washed and water washed solids to provide a recombined whole juice. The result was a more neutral juice that exhibited better sensory and taste properties than the starting juice.

### EXAMPLE 2

A portion of the ethanol washed and water washed solids prepared in accordance with Example 1 is added to an acidified sugar water solution. This is used as a neutral tasting solution to facilitate its use as an addback orange juice production facilitator.

### EXAMPLE 3

Juice from Hamlin round oranges which were harvested early in the Hamlin harvesting season is subjected to washing as generally specified in Example 1. This particularly negative juice is greatly improved in flavor by the recombining approach noted herein. More particularly, the washed solids from this juice are recombined with the separated serum portion of the juice for a much-improved Hamlin juice source. Limonin, a large portion of which is found in the solids fraction of the Hamlin juice, was removed, as is a large percentage of the oil in the original juice. A flavor-enhanced juice is thus produced without having to add components to the original juice.

### EXAMPLE 4

A supply of “tight end” orange juice has a typical bitter taste and is not as desirable as other orange juice sources because of relatively high concentrations of oil and negative compounds. Processing in accordance with Example 1 results in neutralization of the separated solids, thereby providing a more acceptable orange juice source. Addition of a flavor addback provides a further flavor benefit. The washing procedure dissolves the limonin, facilitating its removal from the juice solids and thus reducing the bitterness of the tight end juice.

### EXAMPLE 5

The byproduct from the washing slurry of Example 1, which is the liquid fraction separated from the juice solids, is subjected to separation treatment. More particularly, compounds in the slurry wash are separated from the ethanol. Positive and negative compounds are separated by chromatography in accordance with approaches generally known to those skilled in the art. The thus-separated compounds which have positive attributes for juice uses, such as desirable flavor attributes and preferred sensory attributes, are isolated and collected. These positive compounds provide a useful component of a flavor addback system for NFC juices and the like.

### EXAMPLE 6

The procedure as generally described in Example 5 is substantially repeated. This time, the separation technique is distillation. The positive compounds are collected for use in flavor addback systems and the like.

It will be understood that the embodiments of the present invention which have been described are illustrative of some of the applications of the principles of the present invention. Numerous modifications may be made by those skilled in the art without departing from the true spirit and scope of the invention.

1. A method for reducing oil in not-from-concentrate orange juice, comprising:
providing a supply of not-from-concentrate Citrus sinensis orange juice;
separating solids from the Citrus sinensis orange juice to provide a solids fraction containing oil which is separated from the remainder of the juice to provide a reduced-solids Citrus sinensis orange juice supply;
washing said solids fraction of Citrus sinensis orange juice with an organic solvent composition so as to remove at least about 80 weight percent of the oil from said solids fraction and to provide a reduced-oil solids source;
removing substantially all of said organic solvent composition from said reduced-oil solids source; and
combining said reduced-oil solids source with said reduced-solids juice supply to provide a whole not-from-concentrate orange juice having a substantially reduced solids content.

2. The method in accordance with claim 1, wherein said separating removes a majority of the solids from the Citrus sinensis orange juice.

3. The method in accordance with claim 1, wherein said washing removes substantially all of the oil from the solids fraction.

4. The method in accordance with claim 1, wherein after said combining, the substantially reduced solids content is reduced by at least about 50 percent of the solids of the supply of not-from-concentrate Citrus sinensis orange juice.

5. The method in accordance with claim 1, wherein said supply of not-from-concentrate Citrus sinensis orange juice is juice from Hamlin round orange cultivars harvested in the early season for such cultivars.

6. The method in accordance with claim 1, wherein said supply of not-from-concentrate Citrus sinensis orange juice is tight end Citrus sinensis orange juice.

7. The method in accordance with claim 1, wherein the separating provides a solids fraction also containing off flavors, and said washing of the solids fraction removes at least a majority of the off flavors.

8. The method in accordance with claim 1, wherein the supply of not-from-concentrate Citrus sinensis orange juice is from Citrus sinensis round orange cultivar fruit harvested outside of peak harvesting time for the cultivar fruit during a growing season thereof.

9. The method in accordance with claim 1, wherein the washing is carried out with an organic solvent composition that includes an alcohol having a carbon chain length of from 2 to 8.

10. The method in accordance with claim 9, wherein said alcohol is ethanol.

11. The method in accordance with claim 1, wherein said organic solvent composition includes between about 40 and about 100 weight percent of organic solvent, with the balance being water.

12. The method in accordance with claim 1, wherein said removing comprises flash drying.

13. A Citrus sinensis not-from-concentrate orange juice product produced according to the method of claim 1.

14. A method for reducing the oil content and the off-flavor components of Citrus sinensis unconcentrated juice sources, comprising:
providing a supply of Citrus sinensis unconcentrated orange juice;
separating solids from the Citrus sinensis unconcentrated orange juice supply to provide a separated solids fraction containing oil and off-flavor components from the orange juice supply, which solids fraction is separated from the remainder of the orange juice to provide a reduced-solids juice source;
washing said separated solids fraction with an organic solvent composition until the oil and the off-flavor components are substantially removed from said separated solids fraction to provide a washed Citrus sinensis solids fraction;
removing substantially all of said organic solvent composition from said washed Citrus sinesis solids fraction; and
combining said washed Citrus sinensis solids fraction with a juice source in order to provide a whole unconcentrated Citrus sinensis orange juice product having a substantially reduced oil content and substantially reduced off-flavor components when compared with the supply of Citrus sinensis unconcentrated orange juice.

15. The method in accordance with claim 14, wherein said separating removes a majority of the solids from the Citrus sinensis orange juice.

16. The method in accordance with claim 14, wherein said washing removes substantially all of the oil from the solids fraction.

17. The method in accordance with claim 14, wherein after said combining, the substantially reduced solids content is reduced by at least about 50 percent of the solids of the supply of unconcentrated Citrus sinensis orange juice.

18. The method in accordance with claim 14, wherein the supply of unconcentrated Citrus sinensis orange juice is from Citrus sinensis round orange cultivar fruit harvested outside of peak harvesting time for the cultivar fruit during a growing season thereof.

19. The method in accordance with claim 14, wherein said supply of unconcentrated Citrus sinensis orange juice is juice from Hamlin round orange cultivars harvested in the early season for such cultivars.

20. The method in accordance with claim 14, wherein said supply of unconcentrated Citrus sinensis orange juice is tight end Citrus sinensis orange juice.

21. The method in accordance with claim 14, wherein the washing is carried out with an organic solvent composition that includes an alcohol having a carbon chain length of from 2 to 8.

22. The method in accordance with claim 14, wherein said organic solvent composition includes between about 40 and about 100 weight percent of organic solvent, with the balance being water.

23. A Citrus sinensis unconcentrated orange juice product produced according to the method of claim 14.

24. A method for recovering positive flavor components from Citrus sinensis orange juice sources and incorporating into a citrus juice product, comprising:
providing a supply of Citrus sinensis orange juice;
separating solids from the Citrus sinensis orange juice supply to provide a separated solids fraction containing oil, an off-flavor component, and a positive flavor component, which solids fraction is separated from the remainder of the juice to provide a reduced-solids juice source;
washing said separated solids fraction with an organic solvent composition until the oil, the off-flavor component, and the positive flavor component are substantially removed from said separated solids fraction to provide a washed Citrus sinensis solids fraction and a washing composition fraction;
recovering a majority of the positive flavor component present in the washing composition fraction; and
adding the thus recovered positive flavor component as a flavor addback to a citrus juice product.

25. The method in accordance with claim 24, wherein the supply of Citrus sinensis orange juice is from Citrus sinensis round orange cultivar fruit harvested outside of peak harvesting time for the cultivar fruit during a growing season thereof.

26. The method in accordance with claim 25, wherein said supply of Citrus sinensis orange juice is juice from Hamlin round orange cultivars harvested in the early season for such cultivars.

27. The method in accordance with claim 24, wherein said supply of unconcentrated Citrus sinensis orange juice is tight end Citrus sinensis orange juice.

28. The method in accordance with claim 24, wherein the washing is carried out with an organic solvent composition that includes an alcohol having a carbon chain length of from 2 to 8 carbon atoms.

29. The method in accordance with claim 24, wherein said organic solvent composition includes between about 40 and about 100 weight percent of organic solvent, with the balance being water.

30. A citrus juice product produced according to the method of claim 24.
